(19) United States
(12) Patent Application Publication
(10) Pub. No.: US 2011/0164982 A1
(43) Pub. Date: Jul. 7, 2011

(54) APPARATUS AND METHOD FOR A LOW DISTORTION WELD FOR ROTORS

(75) Inventor: IAN DAVID WILSON, SIMPSONVILLE, SC (US)

(73) Assignee: GENERAL ELECTRIC COMPANY, SCHENECTADY, NY (US)

(21) Appl. No.: 12/652,946

(22) Filed: Jan. 6, 2010

(51) Int. Cl. F01D 5/02; B23P 15/04

(52) U.S. Cl. 416/198 A; 416/213 R; 29/889.2

(57) ABSTRACT

A rotor includes a first rotor segment having a first outer surface and a second rotor segment having a second outer surface. A mechanical joint is between the first and second rotor segments, and a cavity is radially outward of the mechanical joint and beneath the first and second outer surfaces. A weld bead is between the first and second outer surfaces. A method for manufacturing a rotor includes machining a first rotor segment having a first concentric axis of rotation and machining a second rotor segment having a second concentric axis of rotation. The method further includes aligning the first rotor segment to the second rotor segment radially using a mechanical joint and applying a weld bead over a portion of the first and second rotor segments to connect the first rotor segment to the second rotor segment.

### FIELD OF THE INVENTION

The present invention generally involves an apparatus and method for assembling a rotor. Specifically, the present invention describes a mechanical joint that radially aligns rotor segments.

### BACKGROUND OF THE INVENTION

Gas turbines are widely used in commercial operations for power generation. A typical gas turbine includes a compressor at the front, one or more combustors around the middle, and a turbine at the rear.

The compressor and the turbine typically share a common rotor which extends from near the front of the compressor, through the combustor section, to near the rear of the turbine. Due to the length and size of the rotor, the total weight of the rotor may approach or exceed 100 tons. To facilitate manufacturing, multiple rotor segments may be individually manufactured and machined, and the individual rotor segments may then joined together to form a single rotor.

The assembled rotor typically rotates at speeds of 3000 to 3600 rpm, or greater. As a result, the individual rotor segments must be precisely balanced before being joined together. Perhaps more importantly, the individual rotor segments must be joined together in a manner that provides for a balanced and concentric axis of rotation for the assembled rotor to minimize vibration, distortion, and eccentricities while rotating at operational speeds.

Various methods exist for joining the individual rotor segments to ensure a balanced and concentric axis of rotation for the assembled rotor. For example, low distortion electron beam and laser beam welding may be used to connect the individual rotor segments and radially fix the position of each rotor segment. Each of these low distortion welding techniques, however, require costly equipment.

In addition, after the individual rotor segments are joined together, a stress relief process is needed to relieve weld induced stresses in each weld between the individual rotor segments. In relieving the stress in the welds, however, the stress release process may slightly alter the radial position of the individual rotor segments, creating eccentricities in the assembled rotor. Eccentricities in the assembled rotor created by the stress relief process may be reduced by machining the exterior or by installing counterweights on the interior or exterior of the assembled rotor. However, the additional machining and balancing to remove eccentricities increases the cost, labor, and time associated with manufacturing the rotor. In addition, internal imbalances in the rotor may create unwanted vibrations and/or harmonic oscillations at operational speeds. The vibrations and/or oscillations may adversely affect designed clearances between components connected to the rotor that rotate synchronously with the rotor, such as compressor blades and turbine blades and may damage bearings.

Therefore, the need exists for an improved system and method for assembling rotor segments into a rotor. Ideally, the improved system and method will ensure concentricity of the rotor after welding the rotor segments together without requiring expensive low distortion welding techniques, such as electron beam or laser beam welding. In addition, the system and method may allow post-welding stress relief without creating eccentricities in the assembled rotor.

### BRIEF DESCRIPTION OF THE INVENTION

Aspects and advantages of the invention are set forth below in the following description, or may be obvious from the description, or may be learned through practice of the invention.

In one embodiment of the present invention, a rotor includes a first rotor segment having a first outer surface and a second rotor segment having a second outer surface. The rotor further includes a mechanical joint between the first and second rotor segments and a cavity radially outward of the mechanical joint and beneath the first and second outer surfaces. A weld bead is between the first and second outer surfaces.

Another embodiment of the present invention is a gas turbine. The gas turbine includes a compressor, at least one combustor downstream of the compressor, and a turbine downstream of the compressor. A rotor connects the compressor to the turbine, and the rotor includes a first rotor segment having a first outer surface and a second rotor segment having a second outer surface. The rotor further includes means for radially aligning the first and second rotor segments and a cavity radially outward of the means for radially aligning the first and second rotor segments and beneath the first and second outer surfaces. In addition, the rotor includes means for connecting the first and second outer surfaces.

The present invention also includes a method for manufacturing a rotor. The method includes machining a first rotor segment having a first concentric axis of rotation and machining a second rotor segment having a second concentric axis of rotation. The method further includes aligning the first rotor segment to the second rotor segment radially using a mechanical joint and applying a weld bead over a portion of the first and second rotor segments to connect the first rotor segment to the second rotor segment.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 shows a simplified cross-section of a gas turbine within the scope of the present invention;

FIG. 2 shows a cross-section of an embodiment of a rotor within the scope of the present invention;

FIG. 3 shows a cross-section of a second embodiment of a rotor within the scope of the present invention; and

FIG. 4 shows a cross-section of a third embodiment of a rotor within the scope of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

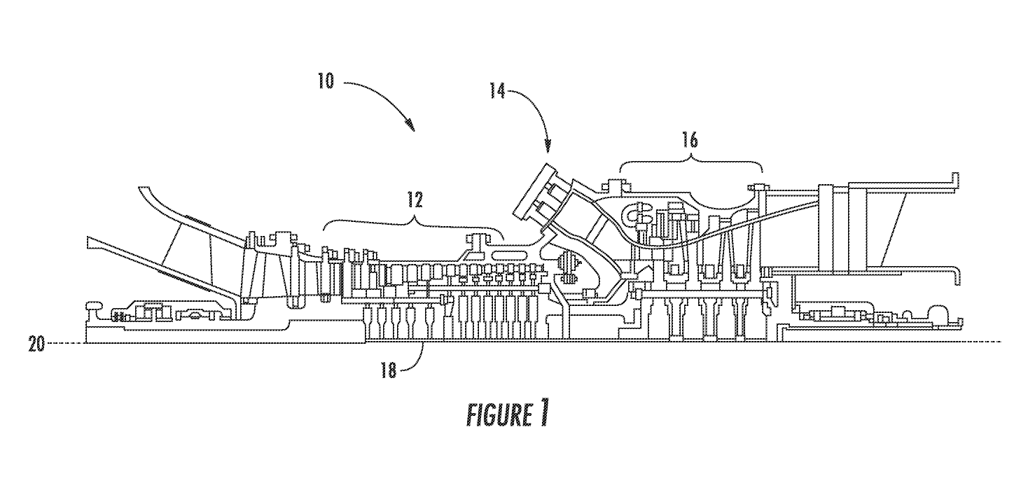

FIG. 1 shows a simplified cross-section of a gas turbine 10 within the scope of the present invention. The gas turbine 10 generally includes a compressor 12 at the front, one or more combustors 14 around the middle, and a turbine 16 at the rear. The compressor 12 and the turbine 16 share a common rotor 18 which extends from near the front of the compressor 12 to near the rear of the turbine 16. The rotor 18 is made from multiple rotor segments which are joined to form a unitary rotor 18 that rotates concentrically on an axis 20 extending along the gas turbine 10. The axis 20 may be, but is not required to be, concentric with the centerline of the gas turbine 10.

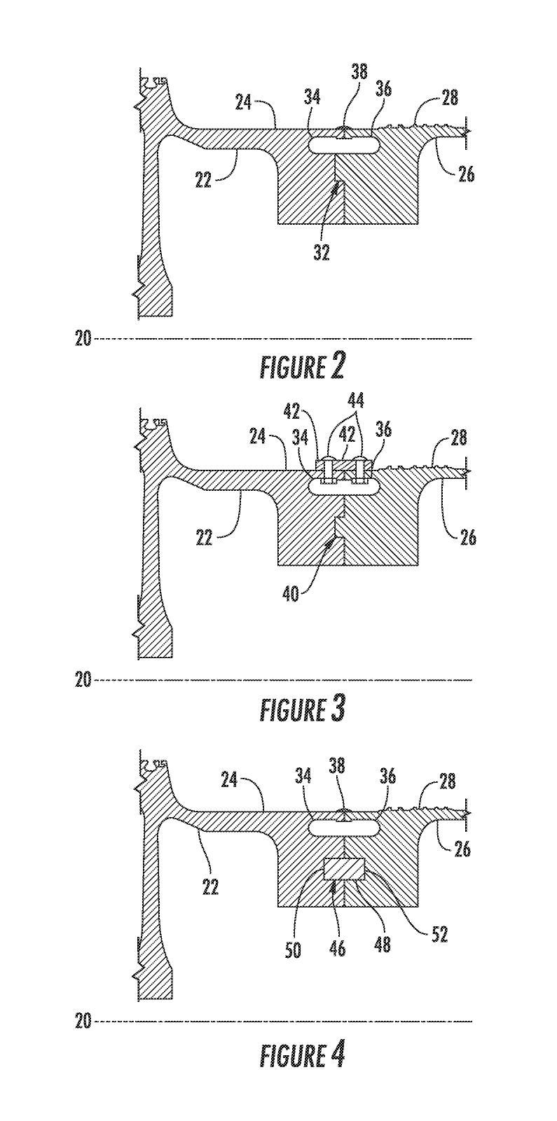

FIG. 2 shows a cross-section of a connection between rotor segments within the scope of the present invention. In this embodiment, the rotor 18 includes a first rotor segment 22 having a first outer surface 24 and a second rotor segment 26 having a second outer surface 28. The first 22 and second 26 rotor segments have been machined and balanced to have a balanced rotational axis that is concentric with the axis 20.

The first 22 and second 26 rotor segments include means for radially aligning the first 22 and second 26 rotor segments so the first 22 and second 26 rotor segments continue to have a balanced axis of rotation when joined that is concentric with the axis 20. The means for radially aligning the first 22 and second 26 rotor segments may be a mechanical joint between the first 22 and second 26 rotor segments. Due to the mass and thickness of the first 22 and second 26 rotor segments, the mechanical joint prevents radial movement of either the first 22 or second 26 rotor segments that can lead to eccentricity in the rotor 18. The mechanical joint may comprise any suitable mechanical joint known in the art for joining two adjacent members and holding the adjacent members radially in place. For example, the mechanical joint may be a simple rabbet joint 32 between the first 22 and second 26 rotor segments, as shown in the embodiment illustrated in FIG. 2. The rabbet joint 32 may extend circumferentially around the first 22 and second 26 rotor segments, or the first 22 and second 26 rotor segments may include multiple rabbet joints 32 spaced around a radius. Other examples of mechanical joints within the scope of the present invention include a dowel joint, a spline, a splice, a tabled splice, a pin and groove, and equivalent joints well-known in the art.

The first 22 and second 26 rotor segments each include a cavity 34, 36 radially outward of the mechanical joint and beneath the first 24 and second 28 outer surfaces. When combined, the first 22 and second 26 rotor segments form a cavity 34, 36 radially outward of the mechanical joint and beneath the first 24 and second 28 outer surfaces.

Means for connecting the first 24 and second 28 outer surfaces connects the first 22 and second 26 rotor segments together to provide tortional strength between the first 22 and second 26 rotor segments. As shown in FIG. 2, the means for connecting the first 24 and second 28 outer surfaces may be a weld bead 38 axially aligned with the underlying cavity 34, 36. In alternate embodiments, the means for connecting the first 24 and second 28 outer surfaces may be a hasp, strap, plate, bridge, or equivalent structures bolted or attached to the first 24 and second 28 outer surfaces.

Axial alignment of the weld bead 38 with the underlying cavity 34, 36 allows the cavity 34, 36 to absorb or mitigate any radial forces created by the weld bead 38. In addition, by placing the weld bead 38 remote from the mechanical joint and separated by the cavity 34, 36, the weld bead 38 is sufficiently remote from the mechanical joint so as to not consume the mechanical joint during the welding process.

The weld bead 38 is sized to be thick enough to carry the torque transmitted by the rotor 18 and to provide overall rotor 18 bending stiffness. In addition, the weld bead 38 is narrow enough such that any radial distortions created by the weld are attenuated by the cavity 34, 36 underlying the weld. As a result, any resulting radial forces created by the weld bead 38 are substantially less than the radial support provided by the mechanical joint, thus ensuring that the weld bead 38 does not create any eccentricities in the assembled rotor 18.

In addition, because the mechanical joint radially aligns the first 22 and second 26 rotor segments and the weld bead 38 merely provides tortional strength between the first 22 and second 26 rotor segments, the present invention does not require the more expensive and time consuming low distortion welding techniques previously employed to assemble rotor components, such as electron beam and laser beam welding. Instead, the weld bead 38 may be applied using any conventional method known in the art for welding two components together. For example, arc welding, TIG welding, and MIG welding may be used to apply the weld bead 38 over the first 24 and second 28 outer surfaces to connect the first 22 and second 26 rotor segments.

The weld bead 38 may be a continuous bead surrounding the circumference of the first 22 and second 26 rotor segments, or the weld bead 38 may comprise interrupted welds performed at spaced apart locations around the perimeter of the first 22 and second 26 rotor segments. If desired, the weld bead 38 may be annealed to remove any stresses created by the application of the weld bead 38. The mass of the mechanical joint holds the rotor segments 22, 26 radially in place and prevents the stress relief process from creating any eccentricities in the assembled rotor 18.

FIG. 3 shows a cross-section of an alternate embodiment within the scope of the present invention. The rotor 18 again includes first 22 and second 26 segments, first 24 and second 28 outer surfaces, and cavities 34, 36 as previously discussed with respect to FIG. 2. In the embodiment illustrated in FIG. 3, the means for radially aligning the first 22 and second 26 rotor segments may be a dado joint 40. The dado joint 40 provides additional radial support for the first 22 and second 26 rotor segments in both the inward and outward directions compared to the rabbet joint 32 shown in FIG. 2. As with the rabbet joint 32 previously discussed, the dado joint 40 may extend circumferentially around the first 22 and second 26 rotor segments, or the first 22 and second 26 rotor segments may include multiple dado joints 40 spaced around a radius.

In the embodiment illustrated in FIG. 3, the means for connecting the first 24 and second 28 outer surfaces may be a hasp 42. Bolts 44 through the hasp 42 and first 24 and second 28 outer surface secure the hasp to the first 22 and second 26 rotor segments to provide tortional support for the rotor 18. In alternate embodiments, the hasp 42 may be spot welded to the first 24 and second 28 outer surfaces.

FIG. 4 shows a cross-section of an alternate embodiment within the scope of the present invention. The rotor again includes first 22 and second 26 segments, first 24 and second 28 outer surfaces, cavities 34, 36, and a weld bead 38 as previously discussed with respect to FIG. 2. In the embodiment illustrated in FIG. 4, the means for radially aligning the first 22 and second 26 rotor segments may be a spliced joint 46. As with the dado joint 40 discussed with respect to FIG. 3, the spliced joint provides additional radial support for the first 22 and second 26 rotor segments in both the inward and outward directions. In addition, the spliced joint 46 may utilize a splice 48 that may be separately machined to fit in corresponding recesses 50, 52 machined into the first 22 and second 26 rotor segments. In this manner, the first 22 and second 26 rotor segments may be separately manufactured, and the location of the recesses 50, 52 may be determined and machining to produce the recesses 50, 52 may be performed during assembly of the first 22 and second 26 rotor segments.

It should be appreciated by those skilled in the art that modifications and variations can be made to the embodiments of the invention set forth herein without departing from the scope and spirit of the invention as set forth in the appended claims and their equivalents.

What is claimed is:

1. A rotor, comprising:
a. a first rotor segment having a first outer surface;
b. a second rotor segment having a second outer surface;
c. a mechanical joint between the first and second rotor segments;
d. a cavity radially outward of the mechanical joint and beneath the first and second outer surfaces;
e. a weld bead between the first and second outer surfaces.

2. The rotor of claim 1, wherein the mechanical joint radially aligns the first and second rotor segments.

3. The rotor of claim 1, wherein the mechanical joint is a rabbet joint.

4. The rotor of claim 1, wherein the mechanical joint is a dado joint.

5. The rotor of claim 1, wherein the mechanical joint is a tabled splice joint.

6. The rotor of claim 1, wherein the weld bead is axially aligned with the cavity.

7. The rotor of claim 1, wherein the weld bead is a continuous bead around at least a portion of the first and second outer surfaces.

8. A gas turbine, comprising:
a. a compressor;
b. at least one combustor downstream of the compressor;
c. a turbine downstream of the compressor; and
d. a rotor connecting the compressor to the turbine, wherein the rotor includes:
i. a first rotor segment having a first outer surface;
ii. a second rotor segment having a second outer surface;
iii. means for radially aligning the first and second rotor segments;
iv. a cavity radially outward of the means for radially aligning the first and second rotor segments and beneath the first and second outer surfaces;
v. means for connecting the first and second outer surfaces.

9. The gas turbine of claim 8, wherein the means for radially aligning the first and second rotor segments includes a mechanical joint.

10. The gas turbine of claim 8, wherein the means for radially aligning the first and second rotor segments includes a rabbet joint.

11. The gas turbine of claim 8, wherein the means for connecting the first and second outer surfaces includes a weld bead.

12. The gas turbine of claim 8, wherein the means for connecting the first and second outer surfaces includes a hasp.

13. The gas turbine of claim 8, wherein the means for connecting the first and second outer surfaces extends around the first and second outer surfaces.

14. A method for manufacturing a rotor, comprising:
a. machining a first rotor segment having a first concentric axis of rotation;
b. machining a second rotor segment having a second concentric axis of rotation;
c. aligning the first rotor segment to the second rotor segment radially using a mechanical joint; and
d. applying a weld bead over a portion of the first and second rotor segments to connect the first rotor segment to the second rotor segment.

15. The method of claim 14, further including annealing the weld bead between the first and second rotor segments.

16. The method of claim 14, further including applying the weld bead continuously around a circumference of the first and second rotor segments.
